(19) United States
(12) Patent Application Publication
(10) Pub. No.: US 2013/0253873 A1
(43) Pub. Date: Sep. 26, 2013

(54) CALIBRATION OF FLOWMETERS

(71) Applicant: FIRST SENSOR AG, Puchheim (DE)

(72) Inventor: Oleg GRUDIN, Montreal (CA)

(73) Assignee: FIRST SENSOR AG, Puchheim (DE)

(21) Appl. No.: 13/848,217

(22) Filed: Mar. 21, 2013

Related U.S. Application Data
(60) Provisional application No. 61/614,099, filed on Mar. 22, 2012.

(51) Int. Cl. G01F 25/00

(52) U.S. Cl. CPC G01F 25/0007
USPC 702/100

(57) ABSTRACT

There is described herein a method for calibrating gas flowmeters comprising only one calibration procedure performed at the device level. The step of calibrating the differential pressure sensor itself may be omitted, and the design of the sensor may therefore be simplified by eliminating the sensor conditioner and instead using a microcontroller on the device for signal processing. This is done by a two-point calibration procedure with the use of three correction coefficients to compensate for the variability of flow tubes and pressure sensors.

### CROSS-REFERENCE TO RELATED APPLICATIONS

This application claims priority under 35 U.S.C. §119(e) from U.S. Provisional Patent Application No. 61/614,099 filed on Mar. 22, 2012, the contents of which are hereby incorporated by reference.

### TECHNICAL FIELD

The present invention relates to the field of calibration of devices used to measure mass or the volumetric flow rate of a liquid or gas and more particularly, to flowmeters comprising a pressure sensor connected in bypass to a flow tube inducing differential pressure as function of measured flow.

### BACKGROUND OF THE ART

Gas flowmeters typically operate on the basis of two functional elements: a) a flow element inducing differential pressure when gas flows through it and b) a pressure sensor measuring the induced differential pressure. If an output signal of the sensor is a monotonic function of the differential pressure and the differential pressure is a monotonic function of the flow, then the value of the flow can be unambiguously defined from the output of the pressure sensor. A calibration curve of a flowmeter which presents the function “flow versus sensor output” depends on the design of the flow tube and on the pressure response of the sensor. Due to the variability in sensor sensitivity and in geometrical parameters of the flow tubes, each individual flowmeter must usually pass through a calibration process.

Thermal type micro-flow sensors are frequently used as low differential pressure sensors in gas flowmeters due to their wide dynamic range, low noise and low offset compared to membrane-type pressure sensors. A specific feature of such a micro-flow sensor is a large nonlinearity of the pressure response and an essential temperature dependence of its sensitivity. Linearization and temperature compensation of these sensors is not a trivial task as it requires special skills, specific calibration equipment, and time and labor associated with the calibration process. For this reason, calibration of the differential pressure sensor is usually performed by the original sensor manufacturer.

In practice, linearized and temperature compensated differential pressure sensors contain a sensor conditioner which can be either integrated with the sensing element on one Silicon chip or be used as a separate IC co-packaged with the sensing element. Typically, the sensor conditioner provides Analog-to-Digital (A-to-D) conversion of the analog output signals from the sensing element, processing of digitized signals, storage of sensor-specific calibration coefficients, lookup tables, and realization of certain digital communication interface(s).

One of the traditional approaches of gas flowmeter calibration is based on the use of pre-calibrated differential pressure sensors with a final calibration of the whole flowmeter. This additional calibration is needed due to the variability of the flow tubes. As a result, two separate calibration processes are usually performed—one on a sensor level (done by the sensor manufacturer) and another on a device level (done by the flowmeter manufacturer).

There is a need to improve the two-part calibration process for gas flowmeters in order to address some of the existing drawbacks.

### SUMMARY

There is described herein a method for calibrating gas flowmeters comprising only one calibration procedure performed at the device level. The step of calibrating the differential pressure sensor itself may be omitted, and the design of the sensor may therefore be simplified by eliminating the sensor conditioner and instead using a microcontroller on the device for signal processing. This is done by a two-point calibration procedure with the use of three correction coefficients to compensate for the variability of flow tubes and pressure sensors.

In accordance with a first broad aspect, there is provided a method for calibrating a flowmeter comprising a flow tube inducing a differential pressure dP as a function of flow f and a pressure sensor connected in bypass to the flow tube and generating an output signal U as function of the differential pressure dP, wherein a nonlinearity of the pressure sensor is negligible in a first sub-range of differential pressures and non-negligible in a second sub-range of differential pressures higher than the first sub-range, the method comprising: defining a flow tube calibration curve as

$$f = F ( \frac{dP}{{c}_{F}} ) ,$$

which is inverse to a flow-to-pressure response dP=c_{F}P_{F}(f), and where c_{F} defines a deviation of the flow-to-pressure response from a nominal response P_{F}(f); defining a pressure sensor calibration curve as dP=c_{P}P_{P}(U,K), where P_{P}(U,1) is a nominal calibration curve and coefficients c_{P} and K define a deviation of the pressure sensor calibration curve from nominal; measuring a first output signal U₁ at a first flow level f₁ when induced differential pressure belongs to the first sub-range at which the nonlinearity of the pressure sensor is negligible; measuring a second output signal U₂ at a second flow level f₂ when induced differential pressure belongs to the second sub-range at which the nonlinearity of the pressure sensor is non-negligible; determining a first correction coefficient C=c_{P}/c_{P} from

$${f}_{1} = F ( \frac{{c}_{P}}{{c}_{F}} {P}_{P} ( {U}_{1} , K ) ) ;$$

and determining a second correction coefficient K from

$${f}_{2} = F ( \frac{{c}_{P}}{{c}_{F}} {P}_{P} ( {U}_{2} , K ) ) .$$

In accordance with a second broad aspect, there is provided a method for determining flow during operation of a flowmeter comprising a flow tube inducing a differential pressure dP as a function of flow f and a pressure sensor connected in bypass to the flow tube and generating an output signal U as function of the differential pressure dP, the method comprising: retrieving from memory a first correction coefficient C=c_{P}/c_{F} and a second correction coefficient K, wherein c_{P} and K correspond to a deviation of an individual pressure sensor calibration curve from nominal, the individual pressure sensor calibration curve defined as dP=c_{P}P_{P}(U,K), where P_{P}(U,1) is a nominal calibration curve, and wherein c_{F} corresponds to a deviation of an individual flow tube flow-to-pressure response dP=c_{F}P_{F} (f) from a nominal response P_{F}(f) and an individual flow tube calibration curve is defined as

$$f = F ( \frac{dP}{{c}_{F}} ) ;$$

determining flow f as a function of the output signal U using

$$f = F ( \frac{{c}_{P}}{{c}_{F}} {P}_{P} ( U , K ) ) .$$

Since coefficients c_{F} and c_{P}, which determine the deviation of a flow tube response and a pressure sensor response from a nominal (or “ideal”) response, cannot be measured individually when a flow tube and a pressure sensor are connected together in one flowmeter, the present method proposes a two measurement calibration process for determining two unknown coefficients. Using the ratio C=c_{P}/c_{F}, full calibration of the flowmeter may be provided.

A sensor response curve should be understood as a function relating an input parameter and a sensor output. For example, a pressure response curve relates an input differential pressure and an output voltage.

Sensitivity is a property of a sensor response curve. For parts of the response curve which are linear, the sensitivity is the slope or proportionality constant relating output and input parameter in that linear portion.

### BRIEF DESCRIPTION OF THE DRAWINGS

Further features and advantages of the present invention will become apparent from the following detailed description, taken in combination with the appended drawings, in which:

FIG. 1 shows a sequence of exemplary calibration steps of the flowmeter comprising a flow tube inducing differential pressure as a second order polynomial function of flow;

FIG. 2 shows a sequence of calibration steps of the flowmeter comprising a flow tube inducing differential pressure as a square function of flow;

FIG. 3 illustrates measured pressure response curves of eight differential pressure sensors;

FIG. 4 presents pressure response curves of artificially uncalibrated sensors;

FIG. 5 shows simulated flow-to-differential pressure curves of the flow tubes;

FIG. 6(a) illustrates an example of a flow-to-voltage response reconstructed after two-point calibration;

FIG. 6(b) presents examples of simulated flow-to-voltage responses of several flowmeters; and

FIG. 7 shows an error of linearization of the flow response of the flowmeter.

It will be noted that throughout the appended drawings, like features are identified by like reference numerals.

### DETAILED DESCRIPTION

The method will be described as applied to a gas flowmeter consisting of two main functional elements—a flow tube and a differential pressure sensor connected in bypass to the flow tube. The flow tube generates differential pressure dP as a monotonic function of the gas flow f passing through it. For the tubes of Venturi- or Pitot-type, or tubes containing a baffle (orifice plate), the differential pressure generated can be expressed as:

dP=af+bf² (1a)

where coefficients a and b define a nominal flow response of the tube. The differential pressure dP is close to a square function of flow at medium and high flow.

Due to variations of geometrical parameters, the actual differential pressure of the individual flow tube may be different from its nominal value:

dP=c_{F}(af+br²) (1b)

where the coefficient c_{F} represents a deviation of the flow-to-pressure response of the flow tube from its nominal response (c_{F}=1 for nominal response).

The differential pressure sensor converts the pressure dP into an electrical output signal U. As described in PCT Patent Application bearing publication No. WO2011/029182, the contents of which are hereby incorporated by reference, the calibration curve of a micro-flow sensor can be approximated as follows:

$$dP = \frac{{c}_{P} {G}_{o} U}{1 - {( \frac{KU}{{U}_{o}} )}^{N}} , \qquad ( 2 )$$

where coefficients Gₒ and Uₒ define the nominal sensitivity and the level of nonlinearity of the sensor, respectively; coefficients c_{P} and K represent a deviation of the actual calibration curve from nominal calibration curve (c_{P}=1 and K=1 for nominal calibration curve); and N represents a coefficient defining curvature of the calibration curve (the higher the N, the more linear the response at low and medium dP and the more rapidly the curve goes up at higher dP).

The calibration method described herein allows calibration of a flowmeter consisting of an uncalibrated flow tube (unknown coefficient C_{F}) and an uncalibrated differential pressure sensor (unknown coefficients c_{P} and K).

In a first step, the calibration coefficients and an analytical formula are defined for the flow response curve. The calibration curve of the flowmeter can be derived from equations (1b) and (2):

$$\begin{matrix}af + {bf}^{2} = \frac{\frac{{c}_{P}}{{c}_{F}} {G}_{o} U}{1 - {( \frac{KU}{{U}_{o}} )}^{N}} & ( 3 a ) \\ f = A [ - 1 + \sqrt{1 + \frac{{c}_{P}}{{c}_{F}} B \frac{{G}_{o} U}{1 - {( \frac{KU}{{U}_{o}} )}^{N}}} ] , & ( 3 b )\end{matrix}$$

where

$$A = \frac{a}{2 b} and B = \frac{4 b}{{a}^{2}} .$$

To define the ratio c_{P}/c_{F}, a first measurement at low flow f₁ is performed. The nonlinearity of the pressure sensor can be neglected at low pressure, and the ratio c_{P}/c_{F} can be found from (3a) using:

$$\frac{{c}_{P}}{{c}_{F}} = \frac{{af}_{1} + {bf}_{1}^{2}}{{G}_{o} {U}_{1}} , \qquad ( 4 )$$

where U₁ is the output signal of the sensor measured at flow f₁.

To define coefficient K, a second measurement at flow f₂ is used. The flow should be high enough to provide an output signal U₂ close to its full scale, where nonlinearity of the sensor pressure response becomes significant. Coefficient K can be found from (3a) after defining of ratio c_{P}/c_{F} in (4):

$$K = \frac{{U}_{o}}{{U}_{2}} {( 1 - \frac{{c}_{P}}{{c}_{F}} \frac{{G}_{o} {U}_{2}}{{af}_{2} + {bf}_{2}^{2}} )}^{\frac{1}{N}} \qquad ( 5 )$$

Therefore just two calibration measurements at flows f₁ and f₂ are used to define device-specific coefficients c_{P}/c_{F} and K, which may be stored in a memory of the device and used later. In real operation, the output signal of the flowmeter U is measured and is used to calculate the actual flow in accordance with equation (3b).

The steps described above were performed using only room temperature calibrations and operations. However, temperature variations may result in distortions of the flow-to-pressure response of the flow tube and the pressure-to-voltage response of the sensor. These distortions can be mathematically described by replacing the set of coefficients in equations (1)-(5) with corresponding temperature-dependent functions as follows:

a→a(T_{F});b→b(T_{P});A→A(T_{F});B→B(T_{F}) (6a)

Gₒ→Gₒ(T_{P});K→KKₒ(T_{P}) (6b)

where T_{F} and T_{P} are the temperatures of gas flow inside the flow tube and the sensor. In general these two temperatures may be different. Gₒ(T) describes temperature dependence of the nominal sensitivity at low differential pressures. Kₒ(T) describes temperature-induced change of the nonlinearity of a pressure response at medium and high pressures. Kₒ(Tₒ)=1 and Gₒ(Tₒ)=Gₒ at room temperature Tₒ.

Functions A(T), B(T), Gₒ(T) and Kₒ(T) may be defined in advance for flow tubes of a same construction and sensors of a same type. These functions represent the best approximation describing temperature behavior of the flowmeters incorporating these two components. None of these functions is meant to be measured during calibration of each individual flowmeter.

Temperature compensation of the flowmeter response may require additional sensors to measure the actual temperature of the gas flow inside the flow tube and the temperature of the pressure sensor. In the latter case, a temperature sensor can be, for example integrated with a pressure-sensitive element or with an on-board microcontroller.

Each one of the temperature-dependent functions may be approximated with a polynomial function and the appropriate approximation coefficients may be stored in a memory. These coefficients may be used for the calculation of values of functions (6a) and (6b) at an operating temperature, which are used further in the calculation of flow in accordance with equation (3b).

The output of the sensor U and temperatures T_{F} and T_{P} may be measured at certain sampling rates. After the coefficients A(T_{F}), B(T_{F}), Gₒ(T_{P}) and Kₒ(T_{P}) are calculated, their values and the value of the sensor output U may be substituted into equation (3b) to calculate flow.

The calculation of analytical expressions such as (3b) may be impossible for simple microcontrollers with a restricted number of computing instructions. Therefore, in some embodiments, lookup tables are used for calculation of flow. For example, lookup tables may be built for analytical functions

$$Z ( U ) = \frac{{G}_{o} U}{1 - {( \frac{U}{{U}_{o}} )}^{N}}$$

and Y(z)=−1+\sqrt{1+z}, and stored in a memory. The same lookup tables may be used for all flowmeters of one type and without being dependent on the calibration coefficients defined during the individual calibration of each flowmeter.

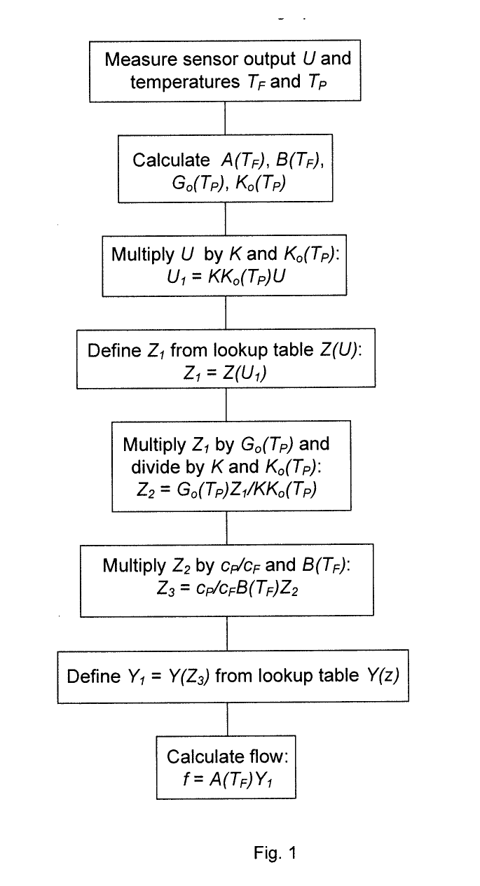

FIG. 1 is a flowchart illustrating an exemplary calculation of flow during operation of the device. In a first step, a sensor output U and temperatures T_{F} and T_{P} are measured. Values are then calculated for A(T_{F}), B(T_{F}), Gₒ(T_{P}) and Kₒ(T_{P}). The sensor output U may then be multiplied by coefficients K and Kₒ(T_{P}), such that U₁=KKₒ(T_{P})U. As per the embodiment described above, the value Z₁=Z(U₁) may be determined from a lookup table for Z(U). The obtained value Z₁ is then multiplied by Gₒ(T_{P}) and divided by KKₒ(T_{P}), resulting in Z₂=Gₒ(T_{P})Z₁/KKₒ(T_{P}). Value Z₂ is multiplied by c_{P}/c_{F} and B(T_{F}) to give

$${Z}_{3} = \frac{{c}_{P}}{{c}_{F}} B ( {T}_{F} ) {Z}_{2} .$$

A second lookup table may again be used to define Y₁=Y(Z₃). Finally, Y₁ is multiplied by A(T_{F}) to calculate flow: f=A(T_{F})Y₁.

To calculate the value of flow using the present method, a limited number of low level microprocessor instructions, like arithmetic addition, multiplication, negation, etc, are used. The calculation of flow can be further simplified if the differential pressure generated by the flow tube is approximated by a pure square function of flow:

dP=c_{F}bf² (7)

In this case, the calibration curve of the flowmeter may be defined as:

$$\begin{matrix}{bf}^{2} = \frac{\frac{{c}_{P}}{{c}_{F}} {G}_{o} U}{1 - {( \frac{KU}{{U}_{o}} )}^{N}} & ( 8 a ) \\ f = \sqrt{\frac{1}{b} \frac{\frac{{c}_{P}}{{c}_{F}} {G}_{o} U}{1 - {( \frac{KU}{{U}_{o}} )}^{N}}} & ( 8 b )\end{matrix}$$

Calibration coefficients c_{P}/c_{F} and K are found as was described above at low flow f₁ and high flow f₂:

$$\begin{matrix}\frac{{c}_{P}}{{c}_{F}} = \frac{{bf}_{1}^{2}}{{G}_{o} {U}_{1}} & ( 9 a ) \\ K = \frac{{U}_{o}}{{U}_{2}} {( 1 - \frac{{c}_{P}}{{c}_{F}} \frac{{G}_{o} {U}_{2}}{{bf}_{2}^{2}} )}^{\frac{1}{N}} & ( 9 b )\end{matrix}$$

The calculation of flow during device operation can be realized with a simpler approach than that described above. One lookup table can be built for the analytical function

$$W ( U ) = \sqrt{\frac{{G}_{o} U}{1 - {( \frac{U}{{U}_{o}} )}^{N}}}$$

and stored in the device memory. Functions 1/\sqrt{b(T)}, \sqrt{Gₒ(T)}, Kₒ(T) and \sqrt{Kₒ(T)} may be defined in advance for flow tubes of a same construction and sensors of a same type, as was described above. Each of these temperature-dependent functions may be approximated with polynomial functions and appropriate approximation coefficients may be stored in the device memory. Coefficients K, \sqrt{K} and \sqrt{c_{P}/c_{F}}, defined at the time of calibration of an individual flowmeter, may also be stored.

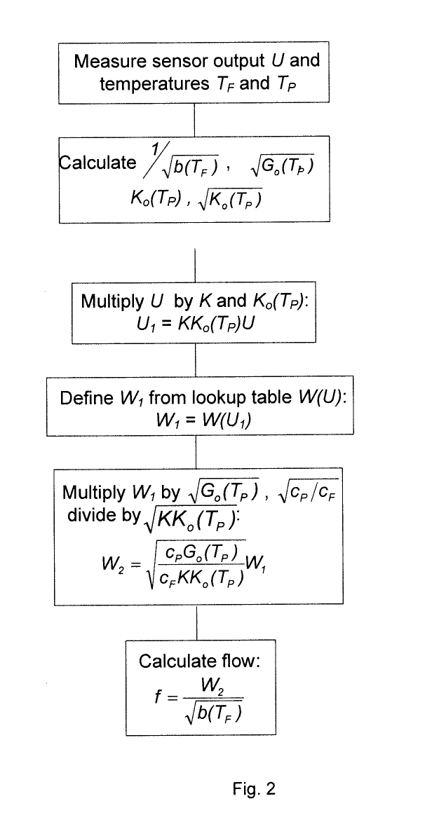

FIG. 2 illustrates exemplary calculation steps, as per FIG. 1, which can be applied for the flowmeter comprising a flow tube inducing a differential pressure dP as a square function of flow. In a first step, the sensor output U and temperatures T_{F} and T_{P} are measured. This is followed by the calculation of values for 1/\sqrt{b(T_{F})}, \sqrt{Gₒ(T_{P})}, Kₒ(T_{P}) and \sqrt{Kₒ(T_{P})}. The sensor output U is multiplied by coefficients K and Kₒ(T_{P}) to give U₁=KKₒ(T_{P})U. The value W₁=W(U₁) may be defined from the lookup table W(U). The obtained value W₁ is then multiplied by \sqrt{Gₒ(T_{P})}, \sqrt{c_{P}/c_{F}} and divided by \sqrt{KKₒ(T_{P})}:

$${W}_{2} = \sqrt{\frac{{c}_{P} {G}_{o} ( {T}_{P} )}{{c}_{F} {KK}_{o} ( {T}_{P} )}} {W}_{1} .$$

Finally, W₂ is multiplied by 1/\sqrt{b(T_{F})} to calculate flow:

$$f = \frac{{W}_{2}}{\sqrt{b ( {T}_{F} )}} .$$

It should be noted that in the presented analysis, the offset of the pressure sensor is assumed to be zero. In practice, an offset compensation procedure may be included into the calibration process. For example, an output of the flowmeter may be measured at zero flow, stored in a memory of the device and subtracted from the measured output signal during operation. In this embodiment, the calibration process may include three measurements—one measurement at zero flow (offset compensation), one measurement at low flow f₁ (defining of coefficient c_{P}/c_{F}), and one measurement at high flow f₂ (defining of coefficient K).

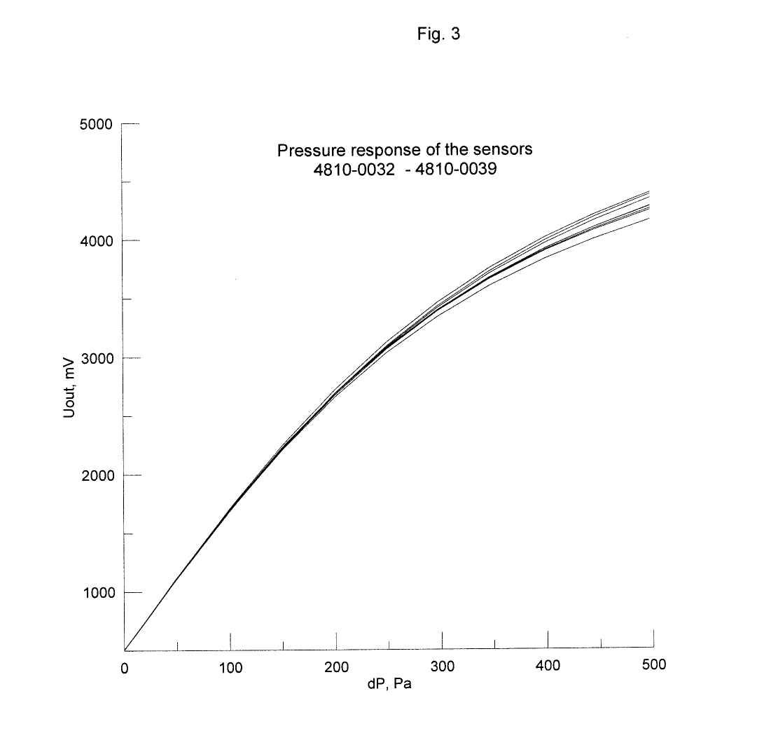

Simulation results of the flowmeter calibration process in accordance with the present method are provided below. The pressure response of a real 500 Pa micro-flow differential pressure sensor was used in simulation. FIG. 3 shows the measured pressure response of eight pressure sensors passed through calibration of low pressure sensitivity. The sensors have different nonlinearities at medium and high pressures and the same sensitivity at low pressures. The parameters of the reference calibration curve for the sensors are Gₒ=0.081 Pa/mV, Uₒ=5525 mV, N=2.2.

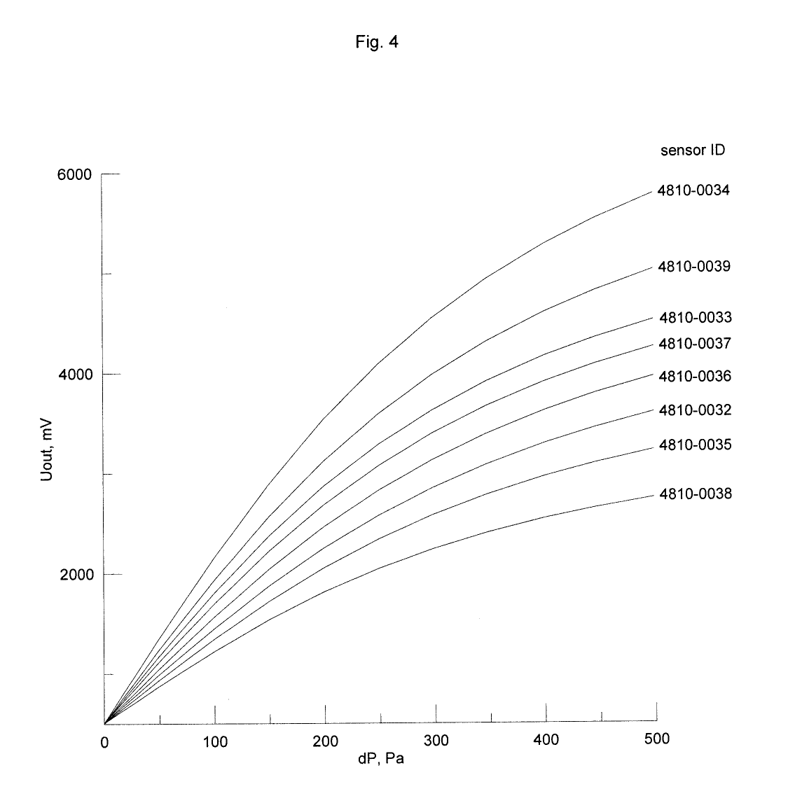

To imitate uncalibrated sensors, their response was multiplied by random numbers from 0.6 to 1.4, which is equivalent to +/−40% variation of sensitivity. Simulated pressure-to-voltage curves derived from initial pressure responses are illustrated in FIG. 4.

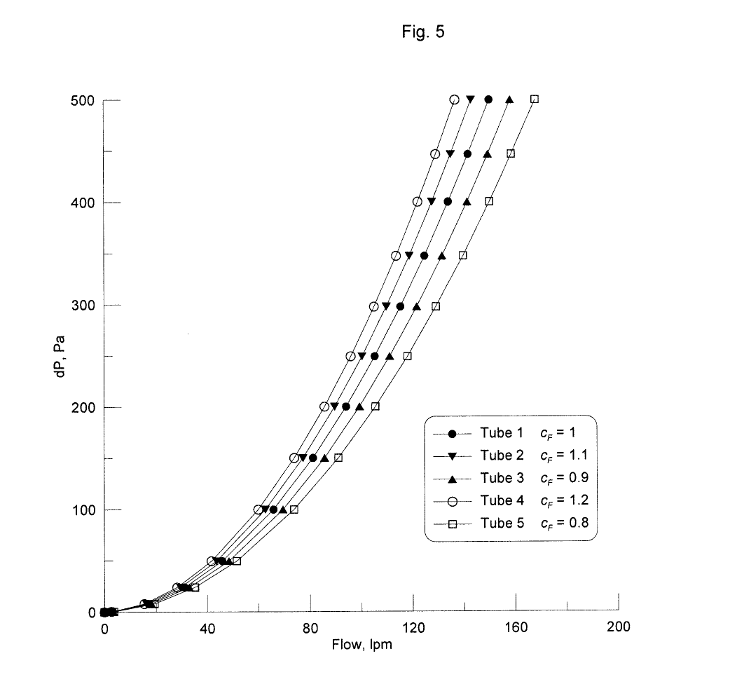

A hypothetical flow tube was modeled to create a flow-to-pressure response (as per equation (1b)), with a=0.1 Pa/lpm, b=0.0215 Pa/lpm² and c_{F}=1. The flow tube generates 500 Pa differential pressure at 150 lpm flow. To imitate the variability of flow tubes, coefficient c_{F} was chosen to be 0.8, 0.9, 1.1 and 1.2. The flow-to-pressure responses of five hypothetical flow tubes are shown in FIG. 5.

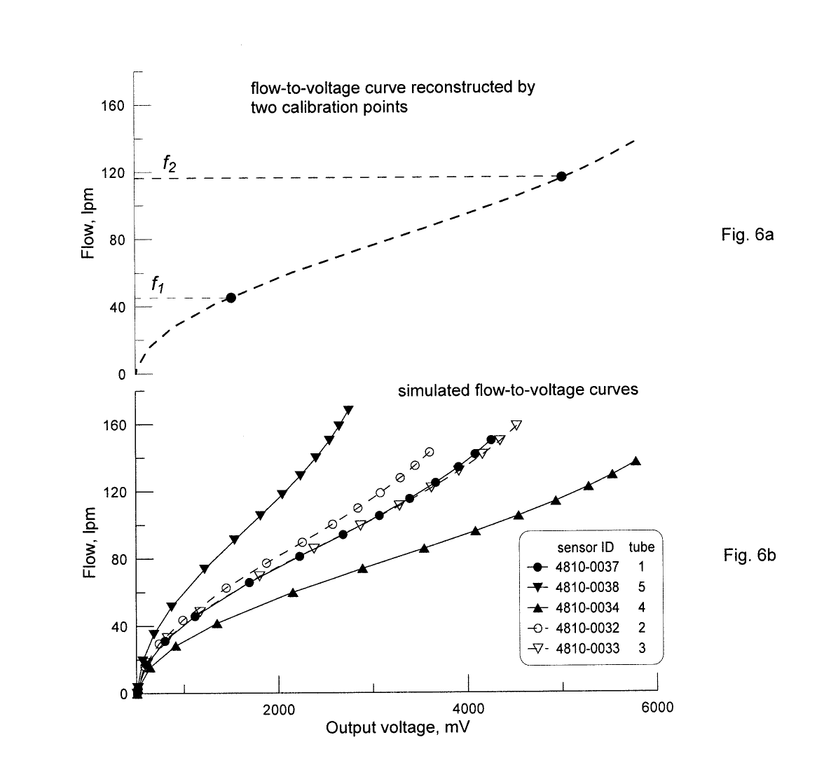

The pressure sensors were initially calibrated at eleven points from 0 to 500 Pa with intervals of approximately 50 Pa. Each pressure-voltage point corresponds to a given flow calculated from equation (1b). Based on this data, a flow-versus voltage curve can be simulated. FIG. 6b gives an example of the flow response of several flowmeters, each “assembled” from one of five flow tubes and one of eight pressure sensors.

To imitate the proposed two-point calibration process, two measurements done at ˜50 Pa and ˜450 Pa were chosen for each sensor. Gas flow values corresponding to these two reference pressures were calculated from equation (1b) for each of the five flow tubes. Eventually, two pairs of flow-voltage points were chosen for each sensor connected with each of the five flow tubes, as per table 1.

TABLE 1

| dP, Pa | flow | sensor output |
|---|---|---|
| ~50 | f₁ | U₁ |
| ~450 | f₂ | U₂ |

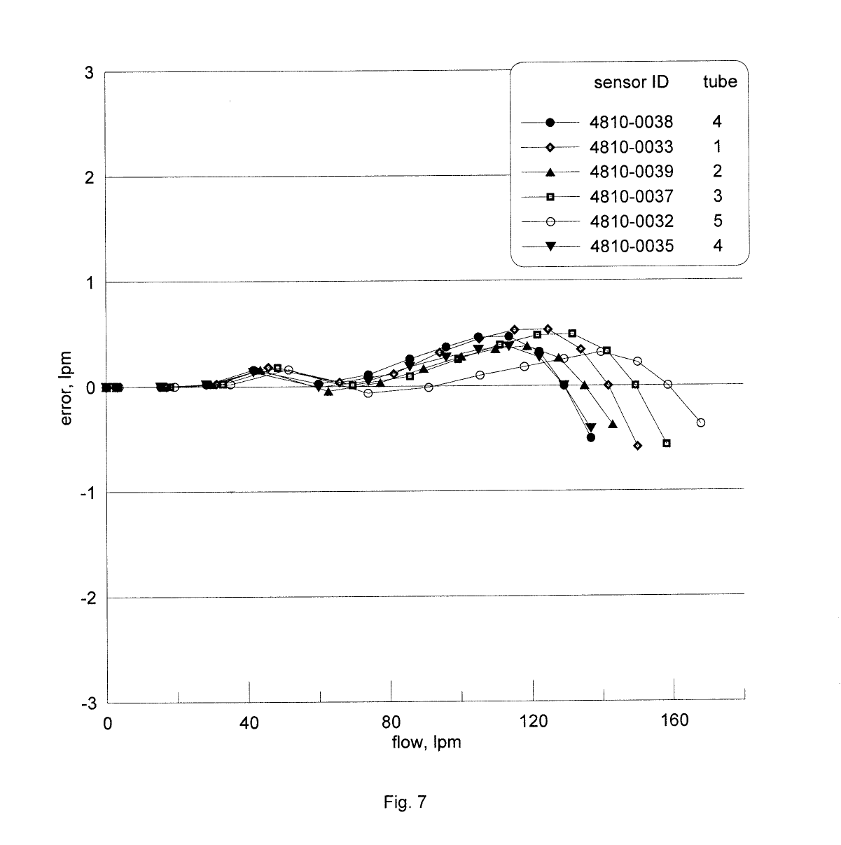

Coefficients c_{P}/c_{F} and K were calculated from equations (4) and (5) for the flowmeter consisting of all possible combinations of pressure sensors and flow tubes. After the two-point calibration, a flow-versus-voltage curve was reconstructed such that flow was calculated for all eleven voltage values in accordance with equation (3b) and compared with the initial curve. The “reconstructed” flow response of the flowmeter, built after two-point calibration, is shown in FIG. 6a. Deviations of the reconstructed curves from the simulated ones are shown on FIG. 7 for some combinations of the pressure sensors and flow tubes. The data indicates that the maximum deviation is less than 0.8 lpm for all possible combinations of the sensors and flow tubes.

It should be understood that the embodiments described above serve as examples for the demonstration of the proposed method of flowmeter calibration. There are possible modifications of the described embodiments which do not change the main principles of the method. For example instead of equation (2) describing pressure response of the sensor, another approximation function can be used:

$$dP = \frac{{c}_{P} {G}_{o} U}{1 - {( \frac{KU}{{U}_{o}} )}^{N}} \frac{1}{1 - {( \frac{KU}{{U}_{o 1}} )}^{{N}_{1}}} \qquad ( 10 )$$

Calculation of the coefficient K from equation (10) can be done numerically.

A more generic case of the method may be considered as follows. The flow tube generates differential pressure dP as a monotonic function of flow f as:

dP=c_{F}P_{F}(f) (11)

where P_{F}(f) is the nominal flow-to-pressure response. The function f=F(dP) inverse to the function dP=P_{F}(f) is determined to define flow from the measured differential pressure as follows:

$$f = F ( \frac{dP}{{c}_{F}} ) \qquad ( 12 )$$

A pressure sensor connected in bypass to the flow tube and measuring differential pressure dP has a generic calibration curve as follows:

dP=c_{P}P_{P}(U,K) (13a)

where coefficients c_{P} and K define a deviation of the individual sensor pressure response from the nominal response. It is assumed that at low pressure, the sensor response is essentially linear and does not depend on coefficient K, thus giving:

dP=c_{P}GₒU (13b)

where Gₒ is the nominal low-pressure sensitivity.

The equation used for calculation of the calibration coefficient c_{P}/c_{F} at low flow f₁ may be derived from (12) and (13b):

$${f}_{1} = F ( \frac{{c}_{P}}{{c}_{F}} {G}_{o} {U}_{1} ) \qquad ( 14 )$$

Note that equations (4) and (9a) described above are specific cases of the more general equation (14).

A second calibration coefficient K is found at high flow f₂ from an equation derived from (11) and (12a):

$${f}_{2} = F ( \frac{{c}_{P}}{{c}_{F}} {P}_{P} ( {U}_{2} , K ) ) \qquad ( 15 )$$

Coefficient K can be calculated either numerically, as in equation (10), or analytically as in equations (5) or (9b).

The described calibration method may be used to improve accuracy of flowmeter calibration. It also minimizes the number of calibration points needed for linearization of the flowmeter, as well as the number of calibration coefficients used in linearization. The linearization algorithm is thus simplified, and can be implemented by a microcontroller with minimal usage of computational resources and memory.

It should be understood that in some embodiments, the method may involve one or more additional steps of determining the particular expressions for flow-to-pressure response of a flow tube and calibration curve of a pressure sensor similar to those described above or different therefrom. Alternatively, the method may involve being given functions such as P_{F}(f), F(dP), P_{P}(U,K) and using these functions for the calibration of the flowmeter.

It will be understood by those skilled in the art that the present embodiments are provided by a combination of hardware and software components, with some components being implemented by a given function or operation of a hardware or software system, and many of the data paths being implemented by data communication within a computer application or operating system. The present invention can be carried out as a method, can be embodied in a system or on a computer readable medium. The embodiments of the invention described above are intended to be exemplary only. The scope of the invention is therefore intended to be limited solely by the scope of the appended claims.

1. A method for calibrating a flowmeter comprising a flow tube inducing a differential pressure dP as a function of flow f and a pressure sensor connected in bypass to the flow tube and generating an output signal U as function of the differential pressure dP, wherein a nonlinearity of the pressure sensor is negligible in a first sub-range of differential pressures and non-negligible in a second sub-range of differential pressures higher than the first sub-range, the method comprising:
defining a flow tube calibration curve as
$$f = F ( \frac{dP}{{c}_{F}} ) ,$$
which is inverse to a flow-to-pressure response dP=c_{P}P_{F}(f), and where c_{F} defines a deviation of the flow-to-pressure response from a nominal response P_{F}(f);
defining a pressure sensor calibration curve as dP=c_{P}P_{P}(U,K), where P_{P}(U,1) is a nominal calibration curve and coefficients c_{P} and K define a deviation of the pressure sensor calibration curve from nominal;
measuring a first output signal U₁ at a first flow level f₁ when induced differential pressure belongs to the first sub-range at which the nonlinearity of the pressure sensor is negligible;
measuring a second output signal U₂ at a second flow level f₂ when induced differential pressure belongs to the second sub-range at which the nonlinearity of the pressure sensor is non-negligible;
determining a first correction coefficient C=c_{P}/c_{F} from
$${f}_{1} = F ( \frac{{c}_{P}}{{c}_{F}} {P}_{P} ( {U}_{1} , K ) ) ;$$
and
determining a second correction coefficient K from
$${f}_{2} = F ( \frac{{c}_{P}}{{c}_{F}} {P}_{P} ( {U}_{2} , K ) ) .$$

2. The method of claim 1, wherein the first correction coefficient and the second correction coefficient are stored in a memory and accessed during operation of the flowmeter for determining flow f.

3. The method of claim 1, wherein the nominal response P_{F} (f) of the flow tube is defined as dP=af+bf², where a and b are nominal flow response coefficients.

4. The method of claim 3, wherein the pressure sensor calibration curve is further defined as
$$dP = \frac{{c}_{P} {G}_{o} U}{1 - {( \frac{{KK}_{o} U}{{U}_{o}} )}^{N}} ,$$
where Gₒ defines nominal sensitivity at the first differential pressure, and Uₒ, Kₒ and N represent a level of nonlinearity of the pressure sensor.

5. The method of claim 4, further comprising measuring a flow tube temperature T_{F} and a pressure sensor temperature T_{P} and performing temperature compensation of the output signal U of the flowmeter.

6. The method of claim 5, wherein coefficients a and b are defined as functions of the flow tube temperature T_{F} and coefficients Gₒ and Kₒ are defined as functions of the pressure sensor temperature T_{P}.

7. The method of claim 1, further comprising applying an offset compensation procedure to account for an offset of the pressure sensor.

8. The method of claim 7, wherein applying the offset compensation procedure comprises measuring an output of the flowmeter at zero flow, storing the output of the flowmeter at zero flow in a memory, and subtracting the output of the flowmeter at zero flow from the first output signal U₁ and the second output signal U₂.

9. A method for determining flow during operation of a flowmeter comprising a flow tube inducing a differential pressure dP as a function of flow f a and a pressure sensor connected in bypass to the flow tube and generating an output signal U as function of the differential pressure dP, the method comprising:
retrieving from memory a first correction coefficient C=c_{P}/c_{P} and a second correction coefficient K, wherein c_{P} and K correspond to a deviation of an individual pressure sensor calibration curve from nominal, the individual pressure sensor calibration curve defined as dP=c_{P}P_{P}(U,K), where P_{P} (U,1) is a nominal calibration curve, and wherein c_{F} corresponds to a deviation of an individual flow tube flow-to-pressure response dP=c_{F}P_{F}(f) from a nominal response P_{F} (f) and an individual flow tube calibration curve is defined as
$$f = F ( \frac{dP}{{c}_{F}} ) ;$$
determining flow f as a function of the output signal U using
$$f = F ( \frac{{c}_{P}}{{c}_{F}} {P}_{P} ( U , K ) ) .$$

10. The method of claim 9, further comprising applying an offset compensation procedure to account for an offset of the pressure sensor.

11. The method of claim 10, wherein applying the offset compensation procedure comprises retrieving an output of the flowmeter measured at zero flow and subtracting the output of the flowmeter at zero flow from the output signal.
